(19) United States
(12) Patent Application Publication
(10) Pub. No.: US 2015/0293876 A1
(43) Pub. Date: Oct. 15, 2015

(54) WIRELESS DOCKING WITH MULTIPLE WIRELESS DOCKING CENTERS

(71) Applicant: QUALCOMM Incorporated, San Diego, CA (US)

(72) Inventors: Lochan Verma, San Diego, CA (US); Vijayalakshmi Rajasundaram Raveendran, San Diego, CA (US)

(21) Appl. No.: 14/539,365

(22) Filed: Nov. 12, 2014

Related U.S. Application Data
(60) Provisional application No. 61/979,993, filed on Apr. 15, 2014.
(60) Provisional application No. 62/003,992, filed on May 28, 2014.

(51) Int. Cl. G06F 13/40

(52) U.S. Cl. CPC G06F 13/4081

(57) ABSTRACT

In one example, a computing device is configured to operate as a first wireless docking center, the computing device comprising one or more processors configured to determine the computing device is proximate to a second wireless docking center; and in response to determining the computing device is proximate to the second wireless docking center, configure the computing device to communicate with the second wireless docking center via a wireless communication channel.

This application claims the benefit of U.S. Provisional Application No. 61/979,993, filed Apr. 15, 2014; and U.S. Provisional Application No. 62/003,992, filed May 28, 2014; the entire contents of each of which are incorporated herein by reference.

### TECHNICAL FIELD

This disclosure relates to techniques for wireless docking

### BACKGROUND

There are various ways in which devices communicate with one another. One example way is wireless communication. In some examples, one device functions as a central device with which the other devices communicate wirelessly. In some examples, there may be a plurality of such central devices with which respective devices communicate wirelessly (e.g., a first central device communicates wirelessly with a first set of devices and a second central device communicates wirelessly with a second set of devices).

Docking stations, which may also be referred to as “docks,” are sometimes used to couple electronic devices such as laptop computers to peripherals such as monitors, keyboards, mice, printers, or other types of input or output devices. These docking stations typically require a physical connection between the electronic device and the docking station. Additionally, the electronic device and the docking station typically establish docking communications before docking functions may be used.

### SUMMARY

This disclosure generally describes techniques related to scenarios in which two or more wireless docking centers are proximate to one another, in which each of the wireless docking centers is manages respective sets of devices in respective wireless docking environments. In some examples, a first wireless docking center becomes a device in the set of devices of a second wireless docking center and is no longer configured as a wireless docking center. In some examples, a first wireless docking center functions as a secondary wireless docking center to a second wireless docking center, which functions as a primary wireless docking center.

In one example, a method comprises determining, by a computing device configured to operate as a first wireless docking center, the computing device is proximate to a second wireless docking center; and by the computing device and in response to determining the computing device is proximate to the second wireless docking center, configuring the computing device to communicate with the second wireless docking center via a wireless communication channel.

In another example, a computing device is configured to operate as a first wireless docking center, the device comprising one or more processors configured to: determine the computing device is proximate to a second wireless docking center; and in response to determining the computing device is proximate to the second wireless docking center, configure the computing device to communicate with the second wireless docking center via a wireless communication channel.

In another example, a computer-readable storage medium stores instructions that when executed by one or more processors cause a computing device configured to operate as a first wireless docking center to: determine the computing device is proximate to a second wireless docking center; and in response to determining the computing device is proximate to the second wireless docking center, configure the computing device to communicate with the second wireless docking center via a wireless communication channel.

In another examples, a computing device is configured to operate as a first wireless docking center, the device comprising: means for determining the computing device is proximate to a second wireless docking center; and means for, in response to determining the computing device is proximate to the second wireless docking center, configuring the computing device to communicate with the second wireless docking center via a wireless communication channel.

The details of one or more examples are set forth in the accompanying drawings and the description below. Other features, objects, and advantages will be apparent from the description, drawings, and claims.

### BRIEF DESCRIPTION OF DRAWINGS

FIGS. 1A-1C are block diagrams illustrating example wireless docking centers operating according to techniques described in this disclosure.

FIG. 2 is a block diagram illustrating an example wireless docking communications stack that includes a wireless docking service according to one or more examples of this disclosure.

FIG. 3 is a block diagram illustrating an example instance of a computing device operating according to techniques described in this disclosure.

FIG. 4 is a flowchart illustrating example modes of operations for first and second wireless docking centers in accordance with one or more examples described in this disclosure.

Like reference characters denote like elements throughout the figures and text.

### DETAILED DESCRIPTION

This disclosure generally describes techniques related to scenarios in which two or more wireless docking centers are proximate to one another, in which each of the wireless docking centers is wirelessly docked to respective sets of devices in respective wireless docking environments. For purposes of illustration, the disclosure uses the following terms that are defined as follows:

Docking—A process by which a WD (Wireless Dockee) learns about the usable PFs (Peripheral Functions/devices) and other WDs advertised by a WDC (Wireless Docking Center), connects to the WDC and to one or all of the PFs and WDs by extension. In some examples, the WD docks with the WDC and one of all of the PFs and WDs with at most one user pairing step.

Wireless Dockee—A device that includes a logical function that makes it capable of docking In some examples described herein, a wireless dockee is a device that can be configured to be a wireless docking center, and when the wireless dockee is not configured to be a wireless docking center, the wireless dockee may be a peripheral device of a wireless docking center.

Wireless Docking Center—A device that includes a logical function that allows the device to coordinate the setup of connection between a WD and full set or subset of all PFs and WDs in a WDN (Wireless Docking Environment), that the Wireless Docking Center manages.

Wireless Docking Environment—An environment in which a set of one or more peripherals and WDs are managed by the WDC.

In some examples, a first device is configured to be a wireless docking center (WDC), referred to as a first WDC, in which the first WDC manages the connection with a first set of peripheral devices. The first set of peripheral devices may be a subset of a plurality of peripheral devices. In other words, there may be a plurality of peripheral devices and a subset of these peripheral devices form a first set of peripheral devices that communicate with the first WDC. The first WDC and the first set of peripheral devices may form a first wireless docking environment.

In addition, there may be a second WDC that manages the connection with a second set of peripheral devices. Similar to above, the second set of peripheral devices may be a subset of a plurality of peripheral devices. In other words, there may be a plurality of peripheral devices and a subset of these peripheral devices form a second set of peripheral devices that communicate with the second WDC. The second WDC and the second set of peripheral devices may form a second wireless docking environment.

The peripheral devices in the first set of peripheral devices may be different than the peripheral devices in the second set of peripheral devices; however, this may not be required in every example. In some cases, one or more peripheral devices in the first set and the second set may be the same peripheral devices.

The first WDC and the second WDC may become proximate to one another, and this proximity may cause one more issues in the docking environments. For instance, one issue may be the behavior of a WDC when the WDC is in proximity of another WDC (e.g., the behavior of the first WDC when in proximity of the second WDC). Another issue may be the behavior of peripheral devices associated with a WDC when the WDC is in proximity of another WDC (e.g., the behavior of the first set of peripheral devices when the first WDC is in proximity of the second WDC).

This disclosure describes example techniques, which may address one or more issues that arise in a situation in which different WDCs are proximate to one another. For purposes of illustration, the examples are described with respect to two WDCs being proximate to one another. However, the techniques described in this disclosure are not so limited. The techniques described in this disclosure may be applicable to examples where multiple WDCs are proximate to one another.

In some examples, when the first WDC is proximate to the second WDC, the first WDC may no longer be configured as a WDC, and may instead be configured as a wireless dockee (WD). In these examples, the first set of peripheral devices may become peripheral devices of the second WDC so that the peripheral devices associated with the second WDC include the first set of peripheral devices and the second set of peripheral devices.

In these examples, the first WDC, which is now a WD, may also be a peripheral device for the second WDC. As described above, a WD is a device which has the capabilities of becoming a WDC. When a WD is not functioning as a WDC, the WD may be a peripheral device of a WDC. For example, the device which functions as the first WDC may be configured to no longer be a WDC when proximate to the second WDC. Because the device is no longer functioning as a WDC, but has the capabilities to function like a WDC, the device is a WD.

In this sense, a WD may be considered as a specific example of a peripheral device. For instance, not all peripheral devices can be configured to function as a WDC. However, some types of peripheral devices can be configured to function as a WDC. These types of peripheral devices that can be configured to function as a WDC are referred to as WDs.

In some examples, when the first WDC is proximate to the second WDC, the first WDC may remain configured as a WDC. In these examples, the second WDC functions as a primary WDC and the first WDC functions as a secondary WDC. For instance, the second WDC manages the first WDC, but the first WDC still manages the first set of peripheral devices. In these examples, the second WDC manages the second set of peripheral devices and the first WDC. The second WDC does not directly communicate the first set of peripheral devices, unlike in the earlier example, but does so via the first WDC.

In some examples, the first WDC may determine whether to configure itself as a WD or whether to remain configured as a WDC, but secondary to the second WDC. As described in detail below, various factors may influence and determine whether the first WDC is to configure itself as a WD or whether to remain configured as a WDC, but secondary to the second WDC.

In this way, the multiple wireless docking centers may overcome issues resulting from being in proximity to one another. For example, the techniques described herein may enable a novel wireless docking center behavior, in particular, that of relinquishing a wireless docking session with a wireless dockee (if any) and one or more peripherals to another, proximate wireless docking center and becoming a wireless dockee of the proximate wireless docking center. This may have the further benefit of resource conservation, for devices operating as wireless docking center may use more power to maintain connections than devices operating As another example, the wireless docking centers that assume roles of primary and secondary wireless docking centers may enabling cascaded peripheral functions, whereby peripheral functionality managed by the secondary wireless docking center remains subsumed exclusively within the management domain of the secondary wireless docking center, while enabling the primary wireless docking center to engage the peripherals managed by the secondary wireless docking center via the secondary wireless docking center. The primary wireless docking center may thus avoid establishing new connections to the peripherals managed by the secondary wireless docking center and allow a wireless dockee to the primary wireless docking center use all peripherals managed by the primary wireless docking center and the secondary wireless docking center. In effect, the techniques allow for multiple docking environments when the wireless docking centers establish a primary-secondary wireless docking center relation.

As described in more detail, this disclosure is described with respect to automotive functions; however, the techniques described in this disclosure are not so limited. Examples according to this disclosure relate to employing such techniques where the second WDC forms part of or the entire dashboard in an automobile or other motorized vehicle (e.g., the second WDC is a head unit). The first WDC may be a wireless device such as a mobile phone (e.g., so called smart phones), a tablet, a laptop, and the like. In some examples, the first WDC may be a wireless device and the second WDC may also be a wireless device, and not necessarily within a motorized vehicle (e.g., something other a head unit within a car).

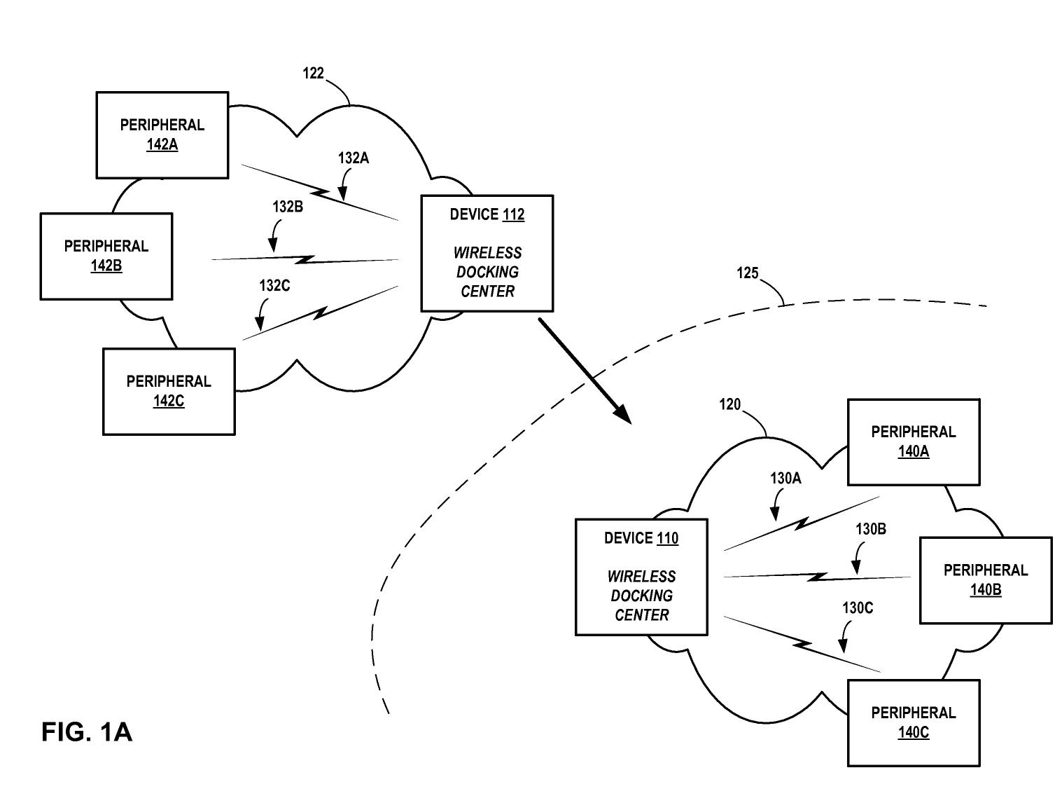

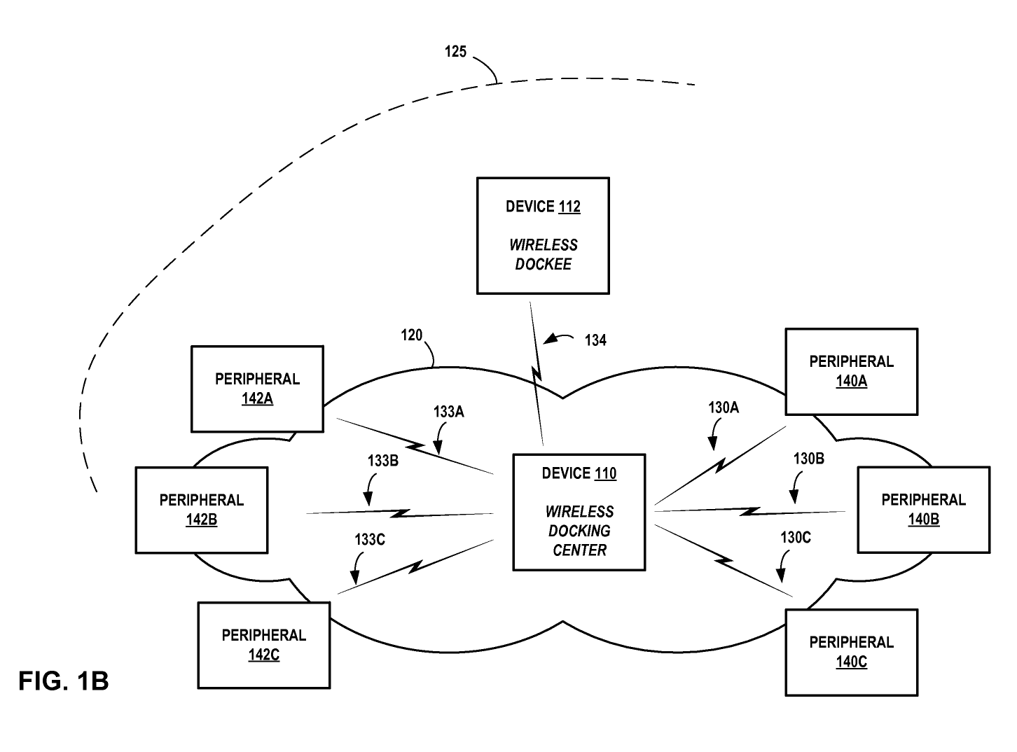

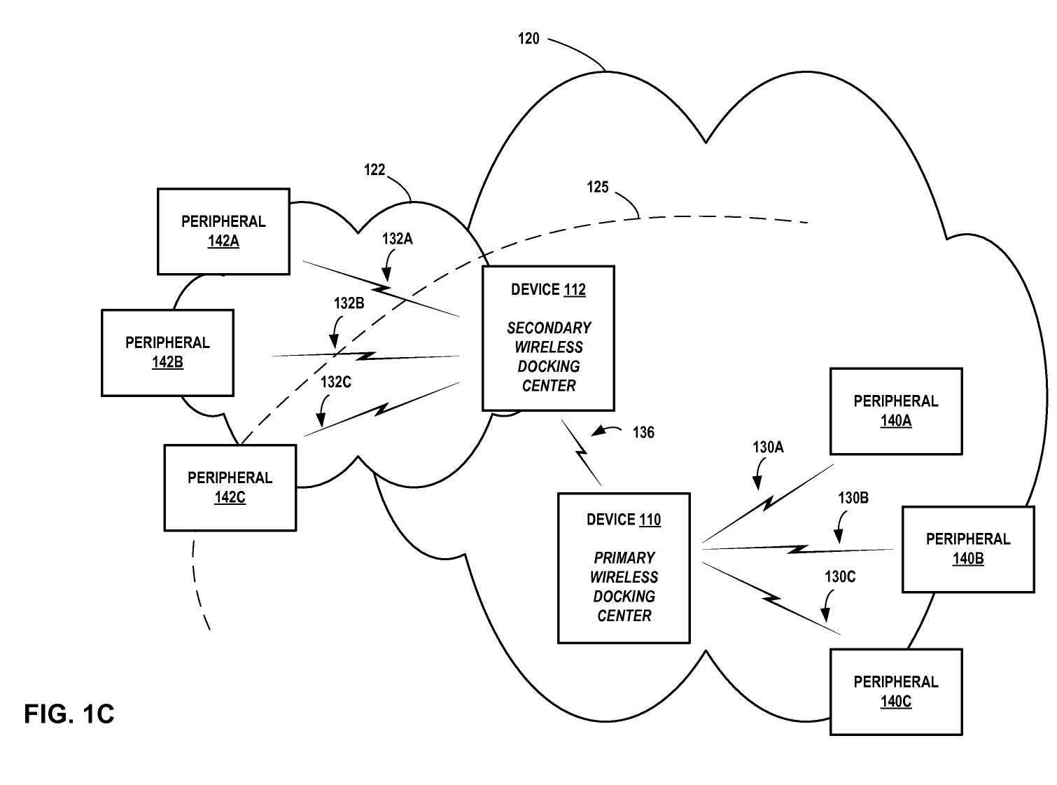

FIGS. 1A-1C are block diagrams illustrating example wireless docking centers operating according to techniques described in this disclosure. FIG. 1A illustrates example wireless docking environments (WDNs) 120, 122 each having an associated wireless docking center and one or more peripheral devices each hosting a peripheral function. Wireless docking environments 120, 122 may alternatively be referred to as Wireless Personal Area Networks (WPANs).

Wireless docking environment 122 includes a computing device 112 operating as a wireless docking center (WDC). Hereinafter, computing device 112 when operating as a wireless docking center may alternatively be referred to as “wireless docking center 112.” Wireless docking center 112 (which may also be referred to as a wireless docking station or wireless docking hub) is communicatively coupled via respective wireless communication channels 132A-132C (“wireless communication channels 132”) with various peripheral devices 142A-142C (“peripherals 142”), which may provide a variety of services that wireless docking center 112 may advertise and make accessible to a wireless dockee (not shown for ease of illustration). Such services may represent peripheral functions.

Wireless docking environment 120 includes a computing device 110 operating as a wireless docking center (WDC). Hereinafter, computing device 110 when operating as a wireless docking center may alternatively be referred to as “wireless docking center 112.” Wireless docking center 110 (which may also be referred to as a wireless docking station or wireless docking hub) is communicatively coupled via respective wireless communication channels 130A-130C (“wireless communication channels 130”) with various peripheral devices 140A-140C (“peripherals 140”), which may provide a variety of services that wireless docking center 110 may advertise and make accessible to a wireless dockee (not shown for ease of illustration). Such services may represent peripheral functions. In some cases, either or both of wireless docking environments 120, 122 may have no associated peripherals at the time of application of the techniques described herein.

Wireless docking centers 112, 110 may each represent a wireless docking host device that serves as a connectivity agent within a computing environment. Wireless docking centers 112, 110 may each represent a dedicated wireless dock, or may also be implemented in a smartphone or other mobile handset, a tablet computer, a laptop computer, an vehicle head unit, gaming console, or other electronic device, or as a component, subsystem, or one or more integrated circuits included as part of a larger device or system of any of the above. In some examples, wireless docking center 110 represents a vehicle head unit, and wireless docking center 112 represents a smart phone or tablet. The vehicle head unit may be inside an automobile or motorized vehicle and may be configured as a wireless docking center. I.e., the head unit includes a logical function that coordinates the setup of connection between one or more peripheral devices (e.g., one or more of the one or more tablet computing devices, a camera, one or more sensors, and a peripheral hard disk) in wireless docking environment 120 that the vehicle head unit (wireless docking center 112) manages. In some examples, wireless docking center 110 represents a television or a gaming console, and wireless docking center 112 represents a smart phone or tablet.

Peripheral devices 140, 142 may include displays, projectors, speakers, keyboards, mice, joysticks, data storage devices, network interface devices, other docking hosts, remote controls, cameras, microphones, printers, disks, wireless Universal Serial Bus (USB) devices, headsets, tablet computers, sensors, or any of various other devices hosting a peripheral function and capable of wireless communication with wireless docking centers, e.g., WDCs 110, 112. Peripheral devices 140, 142 may all be coupled to WDCs 110, 112 via wireless communication channels. In some cases, some of peripheral devices 140, 142 may be coupled to WDCs 110, 112 via wired communication channels. Wireless docking centers 110, 112 may abstract the functions of individual peripheral devices 140, 142 as peripheral functions.

Wireless communication channels 130, 132 may be any channels capable of propagating communicative signals between wireless docking centers 110, 112 on the one hand and peripherals 140, 142 on the other. In some examples, any one or more of wireless communication channels 130, 132 may be implemented in radio frequency communications in frequency bands such as the 2.4 gigahertz (GHz) band, the 5 GHz band, the 60 GHz band, or other frequency bands. In some examples, one or more of wireless communication channels 130, 132 may comply with one or more sets of standards, protocols, or technologies among Wi-Fi (as promoted by the Wi-Fi Alliance), WiGig (as promoted by the Wireless Gigabit Alliance), and/or the Institute of Electrical and Electronics Engineers (IEEE) 802.11 set of standards (e.g., 802.11, 802.11a, 802.11b, 802.11g, 802.11n, 802.11ac, 802.11ad, etc.), or other standards, protocols, or technologies such as Bluetooth and Near-Field Communication NFC. The frequency bands used for wireless communication channels 130, 132, such as the 2.4 GHz, 5 GHz, and 60 GHz bands, may be defined for purposes of this disclosure as they are understood in light of the standards of Wi-Fi, WiGig, any one or more IEEE 802.11 protocols, and/or other applicable standards or protocols.

Although not illustrated in FIG. 1, a wireless dockee may establish communication with any of wireless docking center 110, 112 over a wireless communication channel once the wireless dockee and the wireless docking center come within operative communication range of each other. The wireless dockee and the wireless docking center may establish such communication automatically or manually in response to a user input. In some examples of FIGS. 1A-1C, a wireless dockee may use a wireless docking service to consolidate communication channels with one or more peripherals into a common context, or “docking session,” that may be used by one or more application(s) executing the wireless dockee to easily connect to and use the peripherals.

Proximity area 125 is defined by a proximity boundary (illustrated with dashed lines) and represents an area in which a wireless computing device is proximate to WDC 110. Wireless docking center 112 moves within proximity area 125, as illustrated (alternatively, the proximity area 125 moves along with wireless docking center 110 to encompass wireless docking center 112). In accordance with techniques described in this disclosure, wireless docking centers 110, 112 may, in response to determining that wireless docking center 112 is within proximity area 125, modify the operation of one or more of wireless docking centers 110, 112.

To determine that wireless docking center 112 is within proximity area 125 of wireless docking center 110, wireless docking centers 112, 110 may use an in-band communication technique that leverages the communication protocol for wireless communication channels 130, 132 (e.g., Wi-Fi). For instance, wireless docking center 112 may determine that it is within proximity area 125 (and thus proximate to WDC 110) when a signal strength (e.g., received signal strength indication or “RSSI”) for a wireless communication channel with wireless docking center 110 (not shown in FIG. 1A) exceeds a threshold. The threshold may be user-configurable.

Wireless docking centers 110, 112 may alternatively use an out-of-band communication channel or technique, i.e., without using the communication protocol underlying wireless communication channels 130, 132. For example, wireless docking center 112 may determine that it is located within proximity area 125 using, e.g., Bluetooth; NFC; Infrared Data Association (IrDA); GSM localization information; time difference of arrival (TDOA) information; Global Positioning System (GPS) coordinates for WDCs 110, 112; among other techniques. For example, wireless docking centers 110, 112 may establish a Bluetooth connection, which indicates that wireless docking centers 110, 112 are within Bluetooth range of one another. The Bluetooth range of wireless docking center 110 may be commensurate with proximity area 125, in which case wireless docking center 112 may determine that that it is located within proximity area 125 based on the Bluetooth connection established between wireless docking centers 110, 112. A similar technique applies for NFC.

Dependent upon various criteria, which may include, e.g., configuration information/settings, user input obtained in response to a proximity determination, and characteristics of their respective computing environments, wireless docking centers 110, 112 may modify their operations such that wireless docking center 112 relinquishes its role of a wireless docking center and becomes a wireless dockee with respect to wireless docking center 110, or such that wireless docking center 112 becomes a secondary wireless docking center with respect to wireless docking center 110.

For example, wireless docking center 112 may be configured to operate as a wireless dockee when in proximity of some types of wireless docking center 110 and to operate as a secondary wireless docking center when in proximity of other types of wireless docking center 110. For instance, wireless docking center 112 may be configured to operate as a wireless dockee when wireless docking center 110 is a vehicle head unit. Alternatively, wireless docking center 112 may be configured to operate as a wireless dockee when wireless docking center 110 is a television. Such configuration may specify particular instances of wireless docking centers as configured by a user, who may configure wireless docking center 112 with the desired behavior vis-à-vis the other wireless docking centers. Such configuration may also specify types of wireless docking centers. In such examples, wireless docking center 110 may provide wireless docking center 112 with its wireless docking center type, which is a criterion for wireless docking center 112 to determine its new mode of operation within proximity area 125. Example wireless docking center types may include battery-powered, AC-powered, television, vehicle head unit, and mobile device, among others.

As another example, in response to determining it is within proximity area 125, wireless docking center 112 may request that a user select its new mode of operation. For instance, wireless docking center 112 may present a prompt to a user that asks the user whether wireless docking center 112 is to operate as a wireless dockee to wireless docking center 110. Alternatively or in addition, the prompt may ask the user whether wireless docking center 112 is to operate as a secondary wireless docking center with respect to wireless docking center 110.

As another example, in response to wireless docking centers 110, 112 determining wireless docking center 112 is within proximity area 125, wireless docking centers 110, 112 may exchange resource information for their respective computing environments. Resource information may include power source information, processing power/capability, memory/storage capabilities, and user interface capabilities (e.g., size of an associated display). Wireless docking center 112 may determine its new mode of operation based on this resource information. For instance, if wireless docking center 110 is wall-powered and wireless docking center 112 is battery-powered, wireless docking center 112 may automatically determine to operate as a second wireless docking center. If wireless docking center 110 has a smaller display (or no display), wireless docking center may automatically determine to operate as a wireless dockee rather than a wireless docking center. Other example criteria for automatically or in user-responsively modifying the mode of operation of wireless docking center 112 are contemplated and should not be considered limited to the examples provided above. In some cases, wireless docking center 112 may continue to operate as a wireless docking center, separately from wireless docking center 110.

Wireless docking centers 110, 112 may advertise resource information such as support for different modes of operation described herein, a resource availability index, and availability. In this context a resource availability index may generally refer to an indication of the amount of resources available to WDC 110 or WDC 112 at the time either or both of WDCs 110, 112 devices are determining whether to assume a new role. A resource may, for example, refer to a tuple, which comprises one or more of whether a device is plugged into a power supply, an amount of remaining battery life, memory availability, CPU utilization, available bandwidth (e.g. Mb/s), etc. The tuple may also include additional characteristics. Power supply set to 0, indicates the device is AC powered and set to 1 indicates battery powered. Remaining Battery life carries the value of battery life in percentage (0-100) and is reserved when power supply is set to 0. CPU utilization is represented in percentage (0-100). Resource availability index is an integer value (0-10) calculated through this tuple. A higher value, or in some implementations a lower value, for a resource availability index may represent richness in resources.

In some examples, the resource availability index may be user customizable, such that a user can control when different modes of operation are configured and when they are not according to values or ranges of the resource availability index. As one example, a user may configure a role determination module (e.g. role determination module 215) of WDC 110 or WDC 112 to only configure a new role if the resource availability index for WDC 112 is below a certain threshold. In other examples, a user may configure the role determination module to configure a new role any time device 112 is acting as a WDC and comes into proximity of WDC 110.

WDCs 110, 112 may advertise their availability to assume new roles. As one example, an availability flag may be set to 0 to indicate that WDC 112 is unavailable for reconfiguration according to techniques described herein. Otherwise, WDC 112 may set the availability flag to 1 to indicate that WDC 112 is available for reconfiguration according to techniques described herein.

In the example of FIG. 1B, computing device 112 upon determining that it is in proximity of wireless docking center 110 (e.g., is located within proximity area 125), relinquishes its role of a wireless docking center with respect to peripherals 142 based on one or more criteria, such as those described above. That is, computing device 112 determines to no longer operate a wireless docking center and configures itself accordingly to relinquish control of peripherals 142 by, e.g., dropping wireless communication channels 132. In addition, wireless docking center 110 assumes control of peripherals 142 by establishing respective wireless communication channels 133 with peripherals 142. Wireless docking center 110 in this way expands wireless docking environment 120 to encompass additional peripherals 142. In some examples, computing device 112 may provide, to wireless docking center 110, a wireless profile that describes wireless communication channels 132 previously established with peripherals 142. The wireless profile may specify, for each channel, a frequency or channel, login information, and a description of associated peripheral 142, for example. Wireless docking center 110 may use information included in the wireless profile to establish communication channels 133 with peripherals 142. The wireless profile may be a Wi-Fi Profile.

In the example illustrated in FIG. 1B, computing device 112 further determines to operate as a wireless dockee with respect to wireless docking environment 120, in response to entering proximity area 125 and according to the criteria. Computing device 112 establishes wireless communication channel 134 for wirelessly docking to wireless docking center 110 and operates as a wireless dockee in order to interact with peripherals 140, 142, via wireless docking center 110 that manages peripherals 140, 142. As a result, computing device 112 no longer operates as a wireless docking center with respect to peripherals 142 but instead transitions to a wireless dockee role. In some cases, computing device 112 may assume a role of a peripheral with respect to wireless docking center 110, rather than that of a wireless dockee.

In the example illustrated in FIG. 1C, computing device 112 upon determining that it is in proximity of wireless docking center 110 (e.g., is located within proximity area 125), transitions to a mode of operation in which it is a secondary wireless docking center with respect to wireless docking center 110 (which becomes the primary docking center in the pairing). As part of this transition, wireless docking centers 110, 112 establish a wireless communication channel 136

As a secondary wireless docking center, wireless docking center 112 retains control and management responsibility over peripherals 142 via already-established wireless communication channels 132. As a result, the wireless docking environment 122 remains substantially unchanged, with peripherals 142 usable by wireless docking center 112. Wireless docking center 110 on the other hand retains control and management responsibility over peripherals 140 via already-established wireless communication channels 130. However, now-primary wireless docking center 110 also obtains, by proxy with secondary wireless docking center 112, the use of peripherals 142 and thereby expands wireless docking environment 120 to encompass secondary wireless docking center 112 and peripherals 142. In effect, secondary wireless docking center 112 may be considered “on-par” with peripherals 140 in that it has the same type of relationship with primary wireless docking center 112 as peripherals 140 (e.g., that of a “primary peripheral”). Peripherals 142 derive their relationship to primary wireless docking center 112, meanwhile, via secondary wireless docking center 110 and may be considered “secondary peripherals.”

In this mode of operation, secondary wireless docking center 112 is managed by primary wireless docking center 110. For example, secondary wireless docking center 112 may present a peripheral function or other function to primary wireless docking center 110 via the wireless docking service by which primary wireless docking center 110 can use peripherals 142. As a result, primary wireless docking center 110 may send secondary wireless docking center 112 a directive for any of peripherals 142, and secondary wireless docking center 112 may control the peripheral accordingly. For example, primary wireless docking center 112 may send secondary wireless docking center 112 a directive to write data to a disk that is one or peripherals 142. IN response, secondary wireless docking center 112 writes the data to the disk via the corresponding wireless communication channel. As used herein, to “use” or “control” a peripheral is to send data and/or instructions to the peripheral or to receive data and/or instructions from the peripheral.

Primary wireless docking center 110 may in some cases direct secondary wireless docking center 112 to modify the operation of wireless docking environment 122. For instance, primary wireless docking center 110 may direct secondary wireless docking center 112 to operate wireless docking environment 122 at a particular frequency (e.g., for wireless communication channels 132) or to drop one or more peripherals 142 from wireless docking environment 122.

In some examples, wireless docking centers 112, 110 manage the wireless docking such that (1) none of peripherals 142 have use of or the ability to access to any of primary wireless docking center 110 or peripherals 140, and/or (2) none of peripherals 140 have use of or the ability to access to any of peripherals 142, though peripherals 140 may have access to secondary wireless docking center 112 and vice-versa. Secondary wireless docking center 112 has use of and access to peripherals 142 and vice-versa.

In the various example modes of operation of wireless docking center 112 illustrated in FIGS. 1B-1C and/or described above, wireless docking center 112 may relinquish one or more of its functions in favor of duplicative functions provided by wireless docking center 110 or its peripherals 142. For example, both wireless docking centers 110, 112 may have a GPS or other mapping function. Upon determining and configuring a new role, wireless docking center 112 may turn off its GPS or other mapping function, for it is redundant and may be provided more cheaply or conveniently by wireless docking center 110.

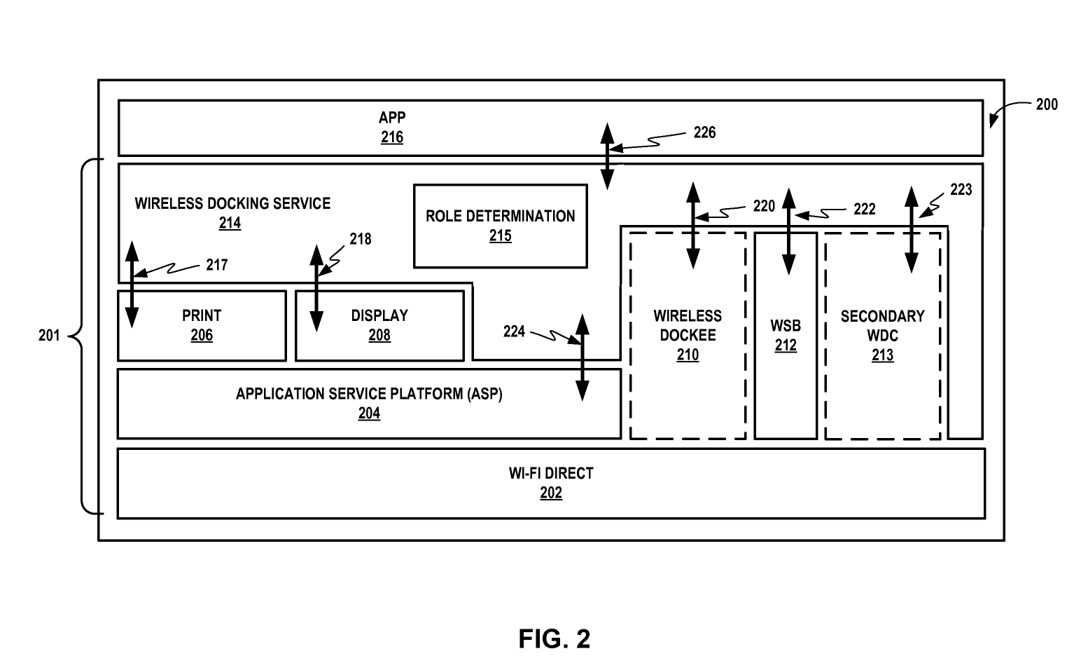

FIG. 2 is a block diagram illustrating an example wireless docking communications stack that includes a wireless docking service according to one or more examples described herein. In the illustrated example, the computing device 200 includes a user application 216 executing over a wireless docking communications stack 201. The computing device 200 may represent and of computing devices 110, 112. Computing device 200 includes a hardware environment (not shown) to execute application 216 and wireless docking communications stack 201.

The wireless docking communications stack 201 includes a wireless docking service 214 that provides an application programming interface (API) 226 to the user application 216. The API 226 includes methods, data fields, and/or events by which the user application 216 may discover, configure, and select peripherals for use. Reference herein to “methods,” “messages,” and “signals,” for instance, with respect to communication between different layers of a communication stack, should be considered interchangeable in that each of these different constructs may be used by the layers of a communication stack to provide/receive data, request an action or data or respond accordingly, or to send/receive a command. The methods, messages, and signals described may represent any of a number of different forms of communication, including messaging services, shared memory, pipes, network communication, and so forth.

Wireless docking is implemented as a wireless docking service (WDS) 214 operating over service and function layers operating over Wi-Fi Direct communications layer 202 (“Wi-Fi Direct 202”), in this example. The Wi-Fi Direct communications are an example implementation of wireless communications over which the ASP 204 may operate. Other example implementations include Bluetooth and NFC. The function layers include a wireless Application Service Platform layer 204 (“ASP 204”) and Wireless Serial Bus (WSB) 112. Other example functions may include Wi-Fi Display or Miracast. According to techniques described herein, depending on a role for computing device 200, function layers may also include a wireless dockee function 210 or secondary wireless docking center function 213 (functions 210 and 213 illustrated in dashed lines to indicate that computing device 200 may operate as a wireless dockee, a secondary wireless docking center, or alternate between the two roles).

Various wireless services may be enabled as interface layers over the ASP 204, including a Print service 206, a Display service 208, and other services in some examples. The wireless docking service 214 operates over each of the Print service 206 and the Display service 208 to provide an interface with the user application 216. The Print service 206 and the Display service 208 may be provided by one or more peripheral devices directly accessible to the computing device 200 and managed via the ASP 204 in some examples.

The WDS 214 may be provided as a Wi-Fi Direct service, and referred to as a Wi-Fi Direct Docking Service. The Wi-Fi Direct Docking Service can be a subset of Wi-Fi docking, in particular, a subset of Wi-Fi docking operating over a P2P Wi-Fi Direct topology, in the example of a Wi-Fi Direct implementation. The WDS 214 may, for example, be implemented as a software module that may be loaded onto or stored in a device such as devices 110, 112. Aspects of the WDS 214 may also be integrated with, pre-packaged with, or implemented in hardware in some examples. For example, the WDS 214 may be stored on, integrated with, or implemented by an integrated circuit or a chipset containing one or more integrated circuits and one or more memory components.

A packet-based transport layer protocol stack (not illustrated) may run on top of ASP 204 and/or WiFi Serial Bus (WSB) 212. The packet-based transport layer may include an Internet Protocol (IP) communications layer and one or more of various Transport Layer communication layers. The IP communications layer may run on top of ASP 204, or directly on Wi-Fi Direct 202. The Transport Layer communications layer may include and one or more of Transmission Control Protocol (TCP), User Datagram Protocol (UDP), Stream Control Transmission Protocol (SCTP), or other Transport Layer communication protocols.

The wireless docking communications stack 201 includes several additional communication interfaces between different components of the wireless docking communications stack 201. A WDS Interface 224 between ASP 204 and the WDS 214 serves as a wireless docking interface for ASP 204 methods and events. The WDS Interface 224 may implement WDS 214 running directly on ASP 204 to manage wireless docking communications directly with one or more peripherals.

Various other communication interfaces are also included in wireless docking communications stack 201. Communication interface 222 between Wi-Fi Serial Bus (WSB) 212 and WDS 214 serves as an interface for controlling and using Wi-Fi Serial Bus operations. Communication interface 217 between the Print service 206 and the WDS 214 serves as an interface for controlling and using the Print service 206 operations. Communication interface 218 between the Display service 208 and the WDS 214 serves as an interface for controlling and using Display service 208 operations. Communication interface 220 between the wireless dockee function 210 and the WDS 214 serves as an interface for controlling and using wireless dockee function 210 operations. Communication interface 223 between the secondary wireless docking center function 213 and the WDS 214 serves as an interface for controlling and using the secondary wireless docking center function 213 operations.

Wireless docking service 214 includes role determination module 215 (“role determination 215”), which may be configured to implement the role determination and configuration techniques described in this disclosure. As introduced above, WDS 214 may establish one or more communication sessions between one or more peripheral devices. As further described above, role determination module 215 may be configured to determine if computing device 200 is in proximity of another wireless docking center device. If computing device 200 is operating as a wireless docking center, role determination module 215 may implement techniques described herein to determine computing device 200 is in proximity of another WDC device by one or more of determining a signal strength of a signal received from the other WDC device meets a threshold, determining a round trip time for a signal sent to the other WDC device meets a threshold, determining a position for itself and\or the other WDC device using a positioning system, and\or by some other means.

In response to determining computing device 200 is in proximity of another WDC device, role determination module 215 may apply operations described above to configure one or more of WDS 214, wireless dockee function 210, and secondary wireless docking center function 213 to configure computing device 200 as a wireless dockee of the other WDC device or as a secondary wireless docking center of the other WDC device. Alternatively, role determination module 215 may apply operations described above to configure one or more of WDS 214, wireless dockee function 210, and secondary wireless docking center function 213 to configure computing device 200 as a primary wireless docking center for the other WDC device, which operates as a secondary WDC device. As part of these operations, WDS 214 may establish a new wireless communication channel with the other WDC device.

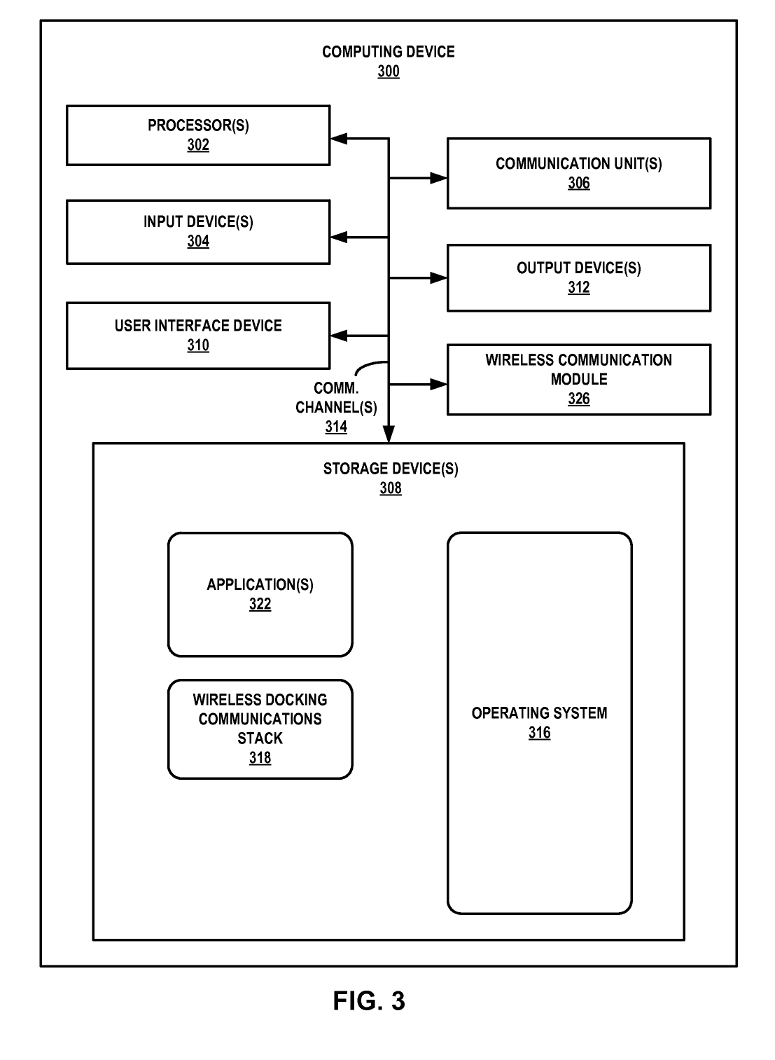

FIG. 3 is a block diagram illustrating an example instance of a computing device 300 operating according to techniques described in this disclosure. FIG. 3 illustrates only one particular example of computing device 300, and other examples of computing device 300 may be used in other instances. Although shown in FIG. 3 as a stand-alone computing device 300 for purposes of example, a computing device may be any component or system that includes one or more processors or other suitable computing environment for executing software instructions and, for example, need not necessarily include one or more elements shown in FIG. 3 (e.g., input devices 304, user interface devices 310, output devices 312). Computing device 300 may represent an example of any of computing devices 110, 112 of FIG. 1 and computing device 200 of FIG. 2.

As shown in the specific example of FIG. 3, computing device 300 includes one or more processors 302, one or more input devices 304, one or more communication units 306, one or more output devices 312, one or more storage devices 308, one or more user interface (UI) devices 310, and wireless communication module 326. Computing device 300, in one example, further includes wireless docking communications stack 318, authorization module 320, one or more applications 322, and operating system 316 that are executable by computing device 300. Each of components 302, 304, 306, 308, 310, 312, and 326 are coupled (physically, communicatively, and/or operatively) for inter-component communications. In some examples, communication channels 314 may include a system bus, a network connection, an inter-process communication data structure, or any other method for communicating data. As one example in FIG. 3, components 302, 304, 306, 308, 310, 312, and 326 may be coupled by one or more communication channels 314. Wireless docking communications stack 318, authorization module 320, and one or more applications 322 may also communicate information with one another as well as with other components in computing device 300. While illustrated as separate modules, any one or more of modules 318 or 320 may be implemented as part of any of applications 322.

Processors 302, in some examples, are configured to implement functionality and/or process instructions for execution within computing device 300. For example, processors 302 may be capable of processing instructions stored in storage device 308. Examples of processors 302 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 308 may be configured to store information within computing device 300 during operation. Storage device 308, in some examples, is described as a computer-readable storage medium. In some examples, storage device 308 is a temporary memory, meaning that a primary purpose of storage device 308 is not long-term storage. Storage device 308, in some examples, is described as a volatile memory, meaning that storage device 308 does not maintain stored contents when the computer is turned off. Examples of volatile memories include random access memories (RAM), dynamic random access memories (DRAM), static random access memories (SRAM), and other forms of volatile memories known in the art. In some examples, storage device 308 is used to store program instructions for execution by processors 302. Storage device 308, in one example, is used by software or applications running on computing device 300 to temporarily store information during program execution.

Storage devices 308, in some examples, also include one or more computer-readable storage media. Storage devices 308 may be configured to store larger amounts of information than volatile memory. Storage devices 308 may further be configured for long-term storage of information. In some examples, storage devices 308 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 300, in some examples, also includes one or more communication units 306. Computing device 300, in one example, utilizes communication unit 306 to communicate with external devices via one or more networks, such as one or more wireless networks. Communication unit 306 may be a network interface card, such as an Ethernet card, an optical transceiver, a radio frequency transceiver, or any other type of device that can send and receive information. Other examples of such network interfaces may include Bluetooth, 4G and Wi-Fi radios computing devices as well as Universal Serial Bus (USB). In some examples, computing device 300 utilizes communication unit 306 to wirelessly communicate with an external device such as a server.

In addition, the computing device 300 may include wireless communication module 326. As described herein, wireless communication module 326 may be active hardware that is configured to communicate with other wireless communication devices. These wireless communication devices may operate according to Bluetooth, Ultra-Wideband radio, Wi-Fi, or other similar protocols. In some examples, wireless communication module 326 may be an external hardware module that is coupled with computing device 300 via a bus (such as via a Universal Serial Bus (USB) port). Wireless communication module 326, in some examples, may also include software which may, in some examples, be independent from operating system 316, and which may, in some other examples, be a sub-routine of operating system 316. In some examples, wireless communication module 326 may execute one or more layers of a communication stack, such as Wi-Fi Direct 202.

Computing device 300, in one example, also includes one or more input devices 304. Input device 304, in some examples, is configured to receive input from a user through tactile, audio, or video feedback. Examples of input device 304 include a presence-sensitive display, a mouse, a keyboard, a voice responsive system, video camera, microphone or any other type of device for detecting a command from a user.

One or more output devices 312 may also be included in computing device 300. Output device 312, in some examples, is configured to provide output to a user using tactile, audio, or video stimuli. Output device 312, in one example, includes a presence-sensitive display, a sound card, a video graphics adapter card, or any other type of device for converting a signal into an appropriate form understandable to humans or machines. Additional examples of output device 312 include a speaker, a cathode ray tube (CRT) monitor, a liquid crystal display (LCD), or any other type of device that can generate intelligible output to a user. In some examples, user interface (UI) device 310 may include functionality of input device 304 and/or output device 312.

Computing device 300 may include operating system 316. Operating system 316, in some examples, controls the operation of components of computing device 300. For example, operating system 316, in one example, facilitates the communication of wireless docking communications stack 318, and application 322 with processors 302, communication unit 306, storage device 308, input device 304, user interface device 310, wireless communication module 326, and output device 312. Wireless docking communications stack 318 and application 322 may also include program instructions and/or data that are executable by computing device 300. As one example, modules 318, 320, and 322 may include instructions that cause computing device 300 to perform one or more of the operations and actions described in the present disclosure. Wireless docking communications stack 318 and application 322 may represent wireless docking communications stack 201 and application 216 of FIG. 3, for example.

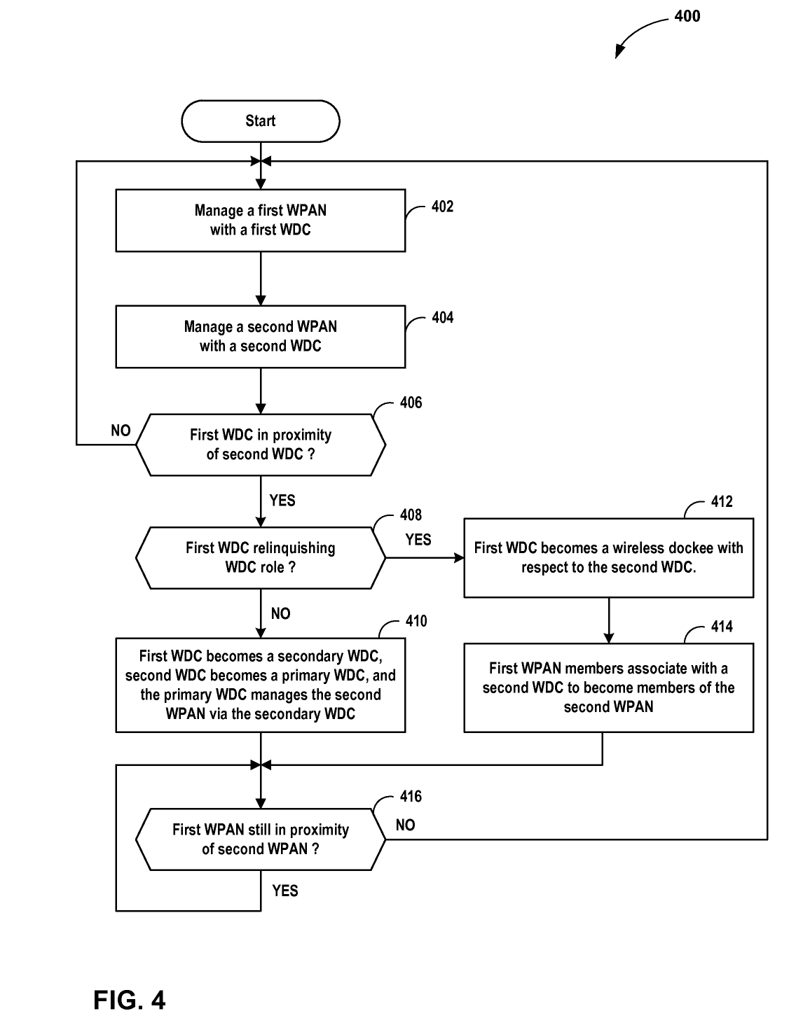

FIG. 4 is a flowchart illustrating example modes of operations for first and second wireless docking centers in accordance with one or more examples described in this disclosure. The terms “first WDC device” and “second WDC device” used with respect to operations 400 below may refer in some examples to wireless docking centers 112 and 110, respectively, of FIG. 1. The terms “first WPAN” and “second WPAN” may refer in some examples to wireless docking environments 122 and 120, respectively, of FIG. 1. The terms “first WPAN members” may refer in some examples to peripherals 142 of wireless docking environment 122 of FIG. 1.

Initially, a first WDC device manages a first WPAN (402) and a second WDC device manages a second WPAN (404). For example, smartphone may be the first WDC device that manages the first WPAN that includes a first set of peripheral devices, and a head unit of as the second WDC device manages the second WPAN that includes a second set of peripheral devices. In some examples, the second WDC device need not necessarily be a head unit of a car. For instance, the second WDC device may be another wireless device including another smartphone, a tablet computing device, or another device that is configured to be a WDC device.

At least one of the first WDC device or the second WDC device may determine whether the first WDC device and the second WDC device are proximate to one another (406). For example, the first WDC device and/or the second WDC device may use in-band or out-of-band techniques for determining if the other WDC device is in proximity.

If the first WDC device is not proximate to the second WDC device (NO branch of 406), then the first and second WDC devices may continue to separately manage the first and second wireless docking environments, respectively. If the first WDC device is proximate to the second WDC device (YES branch of 406), at least one of the first WDC device or the second WDC device may determine the configuration of the first WDC device and may configure the first WDC device based on the determination.

For example, at least one of the first WDC device or the second WDC device may determine whether the first WDC device is no longer to be configured as a WDC device (e.g., whether the first WDC device is to relinquish the WDC role) (20). In general, the first WDC device may determine whether it is no longer to be configured as a WD device. For example, the first WDC device may determine whether the first WDC device is no longer to be configured as a WDC device based on example factors such as pre-configuration, user choice, resource richness (power, computation, memory, GUI), or autonomous behavior. In some examples, the second WDC device may be permanently configured as a WDC device and may not be configurable as a WD device. The first WDC device, on the other hand, may be configurable as a WD device or as a WDC device.

In some examples, a determination of whether the first WDC device is no longer to be configured as a WDC device may not be needed. For instance, in such examples, the first WDC device may be configured to always relinquish its role as a WDC device or configured to always function as a secondary WDC device.

If the first WDC device is no longer to be configured as a WDC device (YES branch of 408), the first WDC device may function as a WD with respect to the second WDC device and the first set of peripheral devices are to be peripheral devices for the second WDC device (414). In other words, the first set of peripheral devices become peripheral devices for the second WDC device in addition to the second set of peripheral devices.

If the first WDC device is to remain configured as a WDC device (NO branch of 408), then the first WDC device may become a secondary WDC device and the second WDC device may become a primary WDC device (410). In this example, the second WDC device manages the first WDC device and the second wireless docking environment. The first WDC device may still manage the first set of peripheral devices (e.g., change the frequency of operation or perform other such controls). In some examples, the second WDC device may control the peripheral devices of the first WDC device via the first WDC device. In these examples, the first WDC device may control the first set of peripheral devices, except when the first WDC device receives a request from the second WDC device. In these cases, the request of the second WDC device to control one or more peripheral devices of the first set of peripheral devices may dominate. In some examples, the second WDC device may control the first WDC device, but may not be able to access the peripheral devices of the first WDC device.

At least one of the first WDC device or the second WDC device may determine whether the first WDC device and the second WDC device are still in proximity (416). If the first WDC device and the second WDC device are no longer proximate to one another (NO branch of 416), the first WDC device and the second WDC device may return to managing respective first and second WPANs. If the first WDC device and the second WDC device are still proximate to one another (YES branch of 416), the first WDC device and the second WDC device may remain configured as previously determined in step 410 or step 414.

In general, the following issues may arise. The behavior of a WDC when in proximity of another WDC may be indeterminate. Also, the behavior of a WD and peripheral devices associated with a WDC when in proximity of another WDC may be indeterminate.

As described above, when a WDC device becomes proximate to the second WDC device, the WDC may no longer be configured as a WDC and may instead function as a peripheral device or wireless dockee for the second WDC. In some example, the WDC device may remain configured as a WDC, but may be a secondary WDC to the second WDC, which functions as a primary WDC.

For example, when a smartphone (e.g., the first WDC device of a first WPAN) is placed inside the car in which a head unit is present (e.g., the second WDC device of a second WPAN), the behavior of the first WDC device and the second WDC device may be indeterminate. Also, when the smartphone is placed inside the car in which the head unit is present, the behavior of the first set of peripherals of the first WPAN and the second set of peripherals of the second WPAN may be indeterminate.

In the techniques described in this disclosure, a first WDC device manages a first wireless docking environment. A second WDC device manages a second wireless docking environment.

In some examples, a determination is made whether the first WDC device and the second WDC device are in proximity of each other (i.e., are proximate to one another). For example, the first WDC device may be configured to determine whether it is in proximity of another WDC device. As another example, the second WDC device may be configured to determine whether it is in proximate of another WDC device. As yet another example, both the first and second WDC devices may be configured to determine whether they are proximate to each other or another WDC device. The proximity determination may be done through in-band (e.g., over Wi-Fi) and/or out-of-band techniques (e.g., BT, NFC, IrDA).

In some examples, if the first WDC device is in proximity to the second WDC device (e.g., the smartphone is inside the car that includes the head unit), the first WDC device may relinquish its role of being a WDC device. The first WDC device may become a wireless dockee (WD) device with respect to the second WDC device and may become a member of the second wireless docking environment (e.g., become a peripheral device within the second WPAN managed by the second WDC device). Also, all the members of the first wireless docking environment (e.g., the first set of peripheral devices) associate with second WDC device (e.g., become peripheral devices of the second WDC device) leveraging Wi-Fi Profile, which may be shared between the first WDC device and the second WDC device. In this way, the first WPAN is dissolved and the second WPAN encompasses all members of the first WPAN.

The first WDC device may configure itself to no longer be a WDC device based on various factors. For example, the decision to relinquish WDC role may be based on pre-configuration, user choice, resource richness (power, computation, memory, GUI), or autonomous behavior.

In some examples, if the first WDC device is in proximity to the second WDC device (e.g., the smartphone is inside the car that includes the head unit), the first WDC device may not relinquish its role of being a WDC device. Rather, the first WDC device may behave (e.g., function) as a secondary WDC, while the second WDC device may behave (e.g., function) as a primary WDC. The secondary WDC may connect to the primary WDC and may be managed by the primary WDC (e.g., the first WDC device connects to the second WDC device and may be managed by the second WDC device).

For example, the primary WDC may direct the secondary WDC to operate its first wireless docking environment (e.g., the first WPAN) on a certain frequency. In some examples, no members of the first wireless docking environment (e.g., the first WPAN), other than the secondary WDC (e.g., the first WDC device) may access the members of the second wireless docking environment (e.g., the second WPAN) operated by the primary WDC (e.g., the second WDC device). Also, members of the second WDC device (e.g., members of the second WPAN) may access no members of the first wireless docking environment (e.g., the first WPAN) other than the secondary WDC (e.g., the first WDC device).

As a result, in some examples, the first WDC device (e.g. smart phone and now a WD device) may be allowed to enter sleep mode without this leading to the disassociation of the wireless docking environment (now the second WPAN including the former first WPAN). This may have the benefit of conserving the limited battery power of the smart phone. The first WDC device may also, in some cases, remain in active mode but power off one or more of its internal functions in favor of a duplicative peripheral function provided by the second WDC device. For example, a smart phone may power off its GPS chip and/or GPS application to save resources required to operate this function. When needed, the smart phone (formerly the first WDC device and now a WD device) may engage the second WDC device to use a peripheral device, managed by the second WDC device and providing GPS functionality, to obtain GPS coordinates or other location information. As such, the techniques may reduce redundancies between the first WPAN and second WPAN.

If the first WDC device and the second WDC device are no longer in proximity, then both devices may revert to original setting. For instance, when no longer in proximity, the first WDC device may manage the first wireless docking environment that includes the first set of peripheral devices, and the second WDC device may manage the second wireless docking environment that includes the second set of peripheral devices. If the first WDC device and the second WDC device are still in proximity, then they may function in accordance with the examples described above.

Many details of this disclosure have been described in the context of an automobile. Several examples of automobile-specific data have been described in this context. The techniques described herein, however, may find a wide variety of applications with numerous other types of vehicles, and the vehicle data may differ for such applications. Any vehicle that includes a display device on a dashboard or some equivalent structure can use one or more of the techniques described herein. The data communicated between the dashboard and the source device may be vehicle-specific and may vary depending on the type of vehicle.

Example vehicles that can employ a head unit in accordance with this disclosure includes automobile, watercraft, aircraft, all-terrain vehicle (ATV), and tanks or other military vehicles, semi-trucks or other transportation vehicles, and bulldozers, tractors, or other heavy machinery, and trains, golf carts, and other types of vehicles. A wide variety of vehicle data and processing of such data is contemplated in examples according to this disclosure.

Many details of this disclosure have been described in the context of an automobile. Several examples of automobile-specific data have been described in this context. As noted above, however, the techniques described herein may find a wide variety of application with numerous other types of vehicles, and the vehicle data may differ for such applications. Any vehicle that includes a display device on a dashboard or some equivalent structure can use one or more of the techniques described herein.

The techniques of this disclosure may be implemented in a wide variety of devices or apparatuses, including a wireless handset, and integrated circuit (IC) or a set of ICs (i.e., a chip set). Any components, modules or units have been described to illustrate functional aspects and do not necessarily require realization by different hardware units.

Accordingly, the techniques described herein may be implemented in hardware, software, firmware, or any combination thereof. If implemented in hardware, any features described as modules, units or components may be implemented together in an integrated logic device or separately as discrete but interoperable logic devices. If implemented in software, the techniques may be realized at least in part by a computer-readable medium comprising instructions that, when executed in a processor, performs one or more of the methods described above. The computer-readable medium may comprise a tangible and non-transitory computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), Flash memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video codec. Also, the techniques could be fully implemented in one or more circuits or logic elements.

Various aspects of the disclosure have been described. These and other aspects are within the scope of the following claims.

What is claimed is:

1. A method comprising:
determining, by a computing device configured to operate as a first wireless docking center, the computing device is proximate to a second wireless docking center; and
by the computing device and in response to determining the computing device is proximate to the second wireless docking center, configuring the computing device to communicate with the second wireless docking center via a wireless communication channel.

2. The method of claim 1, further comprising:
by the computing device and in response to determining the computing device is proximate to the second wireless docking center, determining the computing device is to operate as a wireless dockee with respect to the second wireless docking center; and
configuring the computing device to operate as a wireless dockee with respect to the second wireless docking center.

3. The method of claim 2, wherein the wireless communication channel comprises a first wireless communication channel, the method further comprising:
establishing, by the computing device and prior to determining the computing device is proximate to the second wireless docking center, a second wireless communication channel with a peripheral device that provides a peripheral function usable by the first wireless docking center in order to associate the first wireless docking center and the peripheral function in a wireless docking environment; and
by the computing device and in response to determining the computing device is proximate to the second wireless docking center, relinquishing control of the peripheral device.

4. The method of claim 2, wherein the computing device determines the computing device is to operate as a wireless dockee with respect to the second wireless docking center based at least on one or more of configuration information, user choice, and resource richness of the computing device.

5. The method of claim 1, further comprising:
in response to determining the computing device is proximate to the second wireless docking center, configuring, by the computing device, the computing device to operate as a secondary wireless docking center with respect to the second wireless docking center, the second wireless docking center operating as a primary wireless docking center.

6. The method of claim 5, further comprising:
by the computing device and in response to determining the computing device is proximate to the second wireless docking center, determining the computing device is to operate as a secondary wireless docking center with respect to the second wireless docking center,
wherein the computing device configures the computing device to operate as a secondary wireless docking center with respect to the second wireless docking center based at least on one or more of configuration information, user choice, and resource richness of the computing device.

7. The method of claim 5, wherein the wireless communication channel comprises a first wireless communication channel, the method further comprising:
establishing, by the computing device and prior to determining the computing device is proximate to the second wireless docking center, a second wireless communication channel with a peripheral device that provides a peripheral function usable by the first wireless docking center in order to associate the first wireless docking center and the peripheral function in a wireless docking environment;
by the computing device in response to receiving a directive for the peripheral device from the second wireless docking center, controlling the peripheral device according to the directive.

8. The method of claim 5, wherein the wireless communication channel comprises a first wireless communication channel, the method further comprising:
establishing, by the computing device and prior to determining the computing device is proximate to the second wireless docking center, a second wireless communication channel with a peripheral device that provides a peripheral function usable by the first wireless docking center in order to associate the first wireless docking center and the peripheral function in a wireless docking environment,
wherein the second wireless docking center is unable to access the peripheral device while the computing device is operating as a secondary wireless docking center with respect to the second wireless docking center.

9. The method of claim 1, further comprising:
in response to determining the computing device is proximate to the second wireless docking center, configuring, by the computing device, the computing device to operate as a primary wireless docking center with respect to the second wireless docking center, the second wireless docking center operating as a secondary wireless docking center; and
by the computing device via the second wireless docking center and while operating as a primary wireless docking center with respect to the second wireless docking center, controlling a peripheral device associated with the second wireless docking center in a wireless docking environment managed by the second wireless docking center.

10. The method of claim 1,
wherein the computing device comprises one of a smart phone and a tablet computer, and
wherein the second wireless docking center comprises a vehicle head unit.

11. A computing device configured to operate as a first wireless docking center, the computing device comprising one or more processors configured to:
determine the computing device is proximate to a second wireless docking center; and
in response to determining the computing device is proximate to the second wireless docking center, configure the computing device to communicate with the second wireless docking center via a wireless communication channel.

12. The computing device of claim 11, wherein the one or more processors are further configured to:
in response to determining the computing device is proximate to the second wireless docking center, determine the computing device is to operate as a wireless dockee with respect to the second wireless docking center; and
configure the computing device to operate as a wireless dockee with respect to the second wireless docking center.

13. The computing device of claim 12,
wherein the wireless communication channel comprises a first wireless communication channel, and
wherein the one or more processors are further configured to:
establish, prior to determining the computing device is proximate to the second wireless docking center, a second wireless communication channel with a peripheral device that provides a peripheral function usable by the first wireless docking center in order to associate the first wireless docking center and the peripheral function in a wireless docking environment; and
in response to determining the computing device is proximate to the second wireless docking center, relinquish control of the peripheral device.

14. The computing device of claim 12, wherein the one or more processors are further configured to determine the computing device is to operate as a wireless dockee with respect to the second wireless docking center based at least on one or more of configuration information, user choice, and resource richness of the computing device.

15. The computing device of claim 11, wherein the one or more processors are further configured to, in response to determining the computing device is proximate to the second wireless docking center, configure the computing device to operate as a secondary wireless docking center with respect to the second wireless docking center, the second wireless docking center operating as a primary wireless docking center.

16. The computing device of claim 15,
wherein the one or more processors are further configured to, in response to determining the computing device is proximate to the second wireless docking center, determine the computing device is to operate as a secondary wireless docking center with respect to the second wireless docking center, and
wherein the one or more processors are further configured to configure the computing device to operate as a secondary wireless docking center with respect to the second wireless docking center based at least on one or more of configuration information, user choice, and resource richness of the computing device.

17. The computing device of claim 15, wherein the wireless communication channel comprises a first wireless communication channel, and
wherein the one or more processors are further configured to:
establish, prior to determining the computing device is proximate to the second wireless docking center, a second wireless communication channel with a peripheral device that provides a peripheral function usable by the first wireless docking center in order to associate the first wireless docking center and the peripheral function in a wireless docking environment; and
in response to receiving a directive for the peripheral device from the second wireless docking center, control the peripheral device according to the directive.

18. The computing device of claim 15, wherein the wireless communication channel comprises a first wireless communication channel, and
wherein the one or more processors are further configured to:
establish, prior to determining the computing device is proximate to the second wireless docking center, a second wireless communication channel with a peripheral device that provides a peripheral function usable by the first wireless docking center in order to associate the first wireless docking center and the peripheral function in a wireless docking environment,
wherein the second wireless docking center is unable to access the peripheral device while the computing device is operating as a secondary wireless docking center with respect to the second wireless docking center.

19. The computing device of claim 11, wherein the one or more processors are further configured to:
in response to determining the computing device is proximate to the second wireless docking center, configure the computing device to operate as a primary wireless docking center with respect to the second wireless docking center, the second wireless docking center operating as a secondary wireless docking center; and
via the second wireless docking center and while operating as a primary wireless docking center with respect to the second wireless docking center, control a peripheral device associated with the second wireless docking center in a wireless docking environment managed by the second wireless docking center.

20. The computing device of claim 11,
wherein the computing device comprises one of a smart phone and a tablet computer, and
wherein the second wireless docking center comprises a vehicle head unit.

21. A computer-readable storage medium storing instructions that when executed by one or more processors cause a computing device configured to operate as a first wireless docking center to:
determine the computing device is proximate to a second wireless docking center; and
in response to determining the computing device is proximate to the second wireless docking center, configure the computing device to communicate with the second wireless docking center via a wireless communication channel.

22. The computer-readable storage medium of claim 21, wherein the instructions further cause the computing device to:
in response to determining the computing device is proximate to the second wireless docking center, determine the computing device is to operate as a wireless dockee with respect to the second wireless docking center; and
configure the computing device to operate as a wireless dockee with respect to the second wireless docking center.

23. The computer-readable storage medium of claim 22,
wherein the wireless communication channel comprises a first wireless communication channel, and
wherein the instructions further cause the computing device to:
establish, prior to determining the computing device is proximate to the second wireless docking center, a second wireless communication channel with a peripheral device that provides a peripheral function usable by the first wireless docking center in order to associate the first wireless docking center and the peripheral function in a wireless docking environment; and
in response to determining the computing device is proximate to the second wireless docking center, relinquishing control of the peripheral device.

24. The computer-readable storage medium of claim 22, wherein the instructions further cause the computing device to determine the computing device is to operate as a wireless dockee with respect to the second wireless docking center based at least on one or more of configuration information, user choice, and resource richness of the computing device.

25. The computer-readable storage medium of claim 21, wherein the instructions further cause the computing device to, in response to determining the computing device is proximate to the second wireless docking center, configure the computing device to operate as a secondary wireless docking center with respect to the second wireless docking center, the second wireless docking center operating as a primary wireless docking center.

26. The computer-readable storage medium of claim 25, wherein the instructions further cause the computing device to:
in response to determining the computing device is proximate to the second wireless docking center, determine the computing device is to operate as a secondary wireless docking center with respect to the second wireless docking center,
wherein the computing device configures the computing device to operate as a secondary wireless docking center with respect to the second wireless docking center based at least on one or more of configuration information, user choice, and resource richness of the computing device.

27. The computer-readable storage medium of claim 25,
wherein the wireless communication channel comprises a first wireless communication channel, and
wherein the instructions further cause the computing device to:
establish, prior to determining the computing device is proximate to the second wireless docking center, a second wireless communication channel with a peripheral device that provides a peripheral function usable by the first wireless docking center in order to associate the first wireless docking center and the peripheral function in a wireless docking environment;
in response to receiving a directive for the peripheral device from the second wireless docking center, control the peripheral device according to the directive.

28. The computer-readable storage medium of claim 25,
wherein the wireless communication channel comprises a first wireless communication channel, and
wherein the instructions further cause the computing device to:
establish, prior to determining the computing device is proximate to the second wireless docking center, a second wireless communication channel with a peripheral device that provides a peripheral function usable by the first wireless docking center in order to associate the first wireless docking center and the peripheral function in a wireless docking environment,
wherein the second wireless docking center is unable to access the peripheral device while the computing device is operating as a secondary wireless docking center with respect to the second wireless docking center.

29. The computer-readable storage medium of claim 21, wherein the instructions further cause the computing device to:
in response to determining the computing device is proximate to the second wireless docking center, configure the computing device to operate as a primary wireless docking center with respect to the second wireless docking center, the second wireless docking center operating as a secondary wireless docking center; and
via the second wireless docking center and while operating as a primary wireless docking center with respect to the second wireless docking center, control a peripheral device associated with the second wireless docking center in a wireless docking environment managed by the second wireless docking center.

30. A computing device configured to operate as a first wireless docking center, the computing device comprising:
means for determining the computing device is proximate to a second wireless docking center; and
means for, in response to determining the computing device is proximate to the second wireless docking center, configuring the computing device to communicate with the second wireless docking center via a wireless communication channel.
